(19) United States
(12) Patent Application Publication
(10) Pub. No.: US 2015/0296595 A1
(43) Pub. Date: Oct. 15, 2015

(54) CIRCUIT DEVICE AND AN OBJECT EMBEDDING THE SAME

(71) Applicant: SHEN-KO TSENG, TAIPEI CITY (TW)

(72) Inventor: SHEN-KO TSENG, TAIPEI CITY (TW)

(21) Appl. No.: 14/681,522

(22) Filed: Apr. 8, 2015

(30) Foreign Application Priority Data
Apr. 11, 2014 (CN) 201420175032.0

(51) Int. Cl. H05B 37/02; H05B 33/08

(52) U.S. Cl. CPC H05B 37/0227; H05B 33/0842

(57) ABSTRACT

The present invention provides a circuit device for controlling a plurality of light-emitting devices disposed on an object to light in a sequence. The circuit device includes a motion actuated switch, a controller, and a battery. Each light-emitting device comprises at least two light-emitting diodes (LED) connected oppositely in polarities. The motion actuated switch is triggers the controller in response to a motion of the object. The battery is supplying the circuit device with electrical power. Moreover, the controller is electrically connected to the motion actuated switch and the light-emitting devices respectively, for driving the light-emitting devices to light in a predetermined way by altering the output voltage polarities or values from the controller to the light-emitting devices when triggered by the motion actuated switch.

### BACKGROUND OF THE INVENTION

1. Field of the Invention

The present invention relates to a circuit device, and more particularly, the present invention relates to a circuit device which is used to control a plurality of light-emitting devices disposed on an object to light in a sequence and alter the output voltage polarities or values.

2. Description of the Prior Art

Insufficient lighting is not good for activities at night, which will easily cause some security problems or identification problems. People run or ride at night may be hit by cars due to the insufficient lighting. Additionally, if the streetlight is not bright enough, people probably can not play ball in the court at night. Therefore, it's necessary to develop a device which may increase the security of activities at night for allowing the activities at night to be performed successfully.

Due to the security consideration mentioned above, many shoes comprising light-emitting element are presented to the public. This kind of shoes generally comprises at least one light source, such as light-emitting diode, a power source, such as a battery, and a switch, which is used to connect the battery to the light source for guiding the electrical power to the light source for lighting.

Additionally, the switch can be a simple hand-operated switch which is similar to the hand-operated switch disclosed in the U.S. Pat. No. 4,158,922. The switch also can be a mercury switch. In the mercury switch, a mercury ball can roll back and forth along with the motion of a user in a tube pillar set between a pair of electrodes. More relative description of the mercury switch can be referred in the U.S. Pat. No. 4,848,009. Additionally, the switch also can be a pressure responsive switch, which can respond the weight applied by the user for turning on/off the pressure responsive switch, such as the pressure responsive switch disclosed in the U.S. Pat. No. 5,285,586. Furthermore, the switch can be a spring switch disclosed in the U.S. Pat. No. 5,408,764. The spring switch can vibrate back and forth for forming/breaking the connection with an electrode.

To prolong the life of the battery and provide more noticeable and safer display, the lighting is hoped to be controllable for lighting intermittently, and the lighting is not hoped to light continuously after the switch is switched off. If a noticeable blinking pattern can be generated by light-emitting diodes, the noticeable blinking pattern will be very interesting and noticeable.

### SUMMARY OF THE INVENTION

A category of the present invention is to provide a circuit device, and more particularly, the circuit device of the present invention can alter the output voltage polarities or values for controlling a plurality of light-emitting devices to light in a predetermined way. Furthermore, on the premise of keeping simple close and energy conservation, the present invention can provide more kinds of lighting/blinking pattern to the activities at night with noticeable and sufficient lighting.

According to an embodiment of the present invention, a circuit device used to control a plurality of light-emitting devices disposed on an object comprises:

a motion actuated switch, used to generate a trigger signal in response to a motion of the object;

a controller, electrically coupled to the motion actuated switch; and

a battery, used to supply the motion actuated switch, the controller, and the plurality of light-emitting devices with electrical power;

wherein each light-emitting device comprises two light-emitting diodes connected oppositely in polarities, upon the controller receiving the trigger signal, the controller drives the plurality of light-emitting devices to light in a predetermined way by altering the output voltage polarities or values from the controller to the plurality of light-emitting devices.

According to another embodiment of the present invention, a circuit device used to control a plurality of light-emitting devices comprises:

a motion actuated switch, used to generate a trigger signal in response to a motion;

a controller, electrically coupled to the motion actuated switch, wherein the controller drives the plurality of light-emitting devices to light according to the trigger signal; and

a battery, used to supply the motion actuated switch, the controller, and the plurality of light-emitting devices with electrical power;

wherein each light-emitting device comprises two light-emitting diodes which are coupled to the controller and connected oppositely in polarities, and the controller drives the plurality of light-emitting devices to light by altering the output voltage polarities or values from the controller to the plurality of light-emitting devices.

Besides, each light-emitting device comprises a first terminal, a second terminal, and a first color light-emitting diode and a second color light-emitting diode which are connected oppositely in polarities and positioned between the first terminal and the second terminal, the controller drives the plurality of light-emitting devices to light in a predetermined way by selectively altering the output voltage polarities or values between the first terminal and the second terminal.

According to another embodiment of the present invention, a circuit device comprises:

a motion actuated switch, used to generate a trigger signal in response to a motion; and

a controller, electrically coupled to the motion actuated switch, wherein the controller comprises a plurality of LED pins and a common pin, each LED pin is respectively coupled to a first terminal of a first color light-emitting diode and a second terminal of a second color light-emitting diode, a second terminal of each first color light-emitting diode and a first terminal of each second color light-emitting diode are collectively coupled to the common pin, and the controller selectively alters the output voltage polarities or values between the LED pin and the common pin according to the trigger signal.

According to the light-emitting diodes which are connected oppositely in polarities and the controller which can alter the output voltage polarities or values from the controller to the plurality of light-emitting devices comprised in the circuit device of the present invention, the present invention can provide more kinds of lighting/blinking pattern to the activities at night with noticeable and sufficient lighting on the premise of keeping simple close and energy conservation.

The advantages and spirits of the invention may be understood by the following recitations together with the appended drawings.

### BRIEF DESCRIPTION OF THE APPENDED DRAWINGS

Some of the embodiments will be described in detail, with reference to the following figures, wherein like designations denote like members, wherein:

FIG. 1 shows the schematic three dimensional diagram in an embodiment of the present invention.

FIG. 2 shows the schematic layout diagram of the controller of the present invention.

FIG. 3A shows the schematic blinking diagram in an embodiment of the present invention.

FIG. 3B shows the schematic blinking diagram in another embodiment of the present invention.

FIG. 3C shows the schematic blinking diagram in another embodiment of the present invention.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

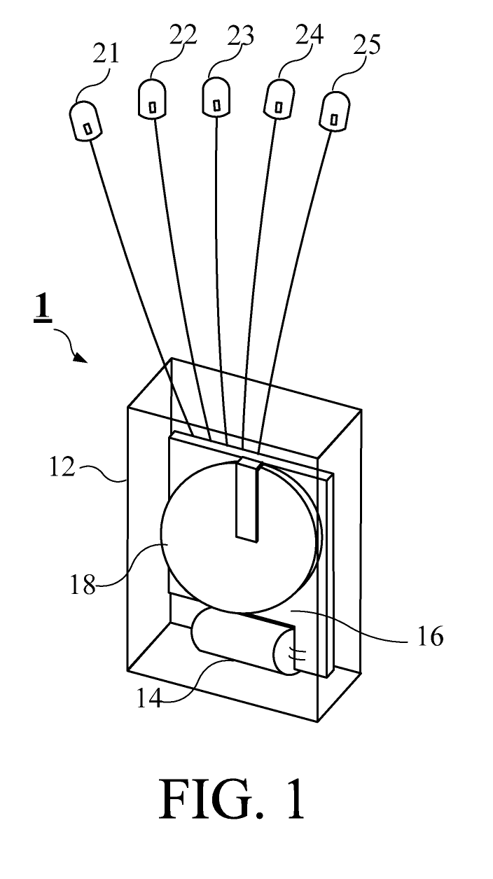

Please refer to FIG. 1. FIG. 1 shows the schematic three dimensional diagram in an embodiment of the present invention. The circuit device 1 of the present invention is used to control a plurality of light-emitting devices 21 to 25 to light in a sequence. As shown in the FIG. 1, the circuit device 1 of the present invention comprises a shell 12, a motion actuated switch 14, a controller 16, and a battery 18.

According to an embodiment of the present invention, the motion actuated switch 14 is fixed in the shell 12, used to respond a motion of the object, such as vibrations or movements, and trigger the controller 16. When the object is vibrating or moving, the motion actuated switch 14 will generate a trigger signal to the controller 16. Additionally, the controller is fixed in the shell 12 as well and electrically coupled to the motion actuated switch 14 and each light-emitting device 21 to 25 respectively for driving the plurality of light-emitting devices 21 to 25 to light in a predetermined way by altering the output voltage polarities or values from the controller to the plurality of light-emitting devices 21 to 25 when the controller is triggered by the motion actuated switch 14. That is to say that upon the controller 16 receives the trigger signal, the controller 16 will drive the plurality of light-emitting devices 21 to 25 to light in a predetermined way.

In an embodiment, each light-emitting device 21 to 25 comprises at least two light-emitting diodes connected oppositely in polarities respectively and then noticeable patterns or colors can be generated when lighting/blinking. The battery 18 is used to supply the circuit device 1 with electrical power. For example, each light-emitting device can comprise a first cannon-shaped package LED and a second cannon-shaped package LED, wherein the positive pole of the first cannon-shaped package LED is connected to the negative pole of the second cannon-shaped package LED, and the negative pole of the first cannon-shaped package LED is connected to the positive pole of the second cannon-shaped package LED. In another embodiment, each light-emitting device comprises a package LED having two pins. The package has a first LED chip and a second LED chip, wherein the positive pole of the first LED chip is connected to the negative pole of the second LED chip, the negative pole of the first LED chip is connected to the positive pole of the second LED chip, and the positive pole of the first LED chip is connected to a pin of the light-emitting device and the positive pole of the second LED chip is connected to the other pin of the light-emitting device.

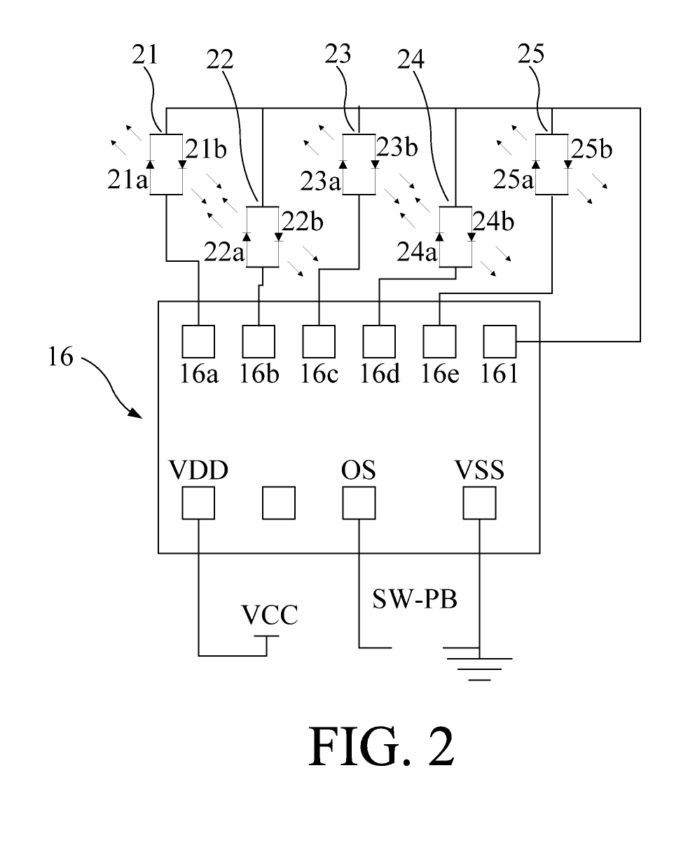

Please refer to FIG. 2. FIG. 2 shows the schematic layout diagram of the controller of the present invention. And the designs and characteristics of the controller 16 are summarized as the following statement. In FIG. 2, VDD means positive pole, VSS means negative pole, and OS means one shot trigger. In one embodiment, the working voltage of the controller 16 is between 1.5 V DC to 7.0 V DC, the minimum output current is 10 mA, the minimum output voltage is 3 V, and the static electricity is smaller than 5 μA.

Wherein each light-emitting device 21 to 25 comprises a first terminal and a second terminal, and comprises a first color light-emitting diode 21a to 25a and a second color light-emitting diode 21b to 25b which are connected oppositely in polarities respectively. The method for forming the first color light-emitting diodes 21a to 25a and the second color light-emitting diodes 21b to 25b comprised in the light-emitting devices 21 to 25 to be connected oppositely in polarities is: each light-emitting diode 21a to 25a and 21b to 25b comprises a positive pole and a negative pole. The positive pole of the light-emitting diode 21a comprised in the light-emitting device 21 is connected to the negative pole of another light-emitting diode 21b and extended to be a first terminal. The negative pole of the light-emitting diode 21a is connected to the positive pole of the light-emitting diode and extended to be a second terminal. The light-emitting diodes 22a to 25a and 22b to 25b comprised in the light-emitting devices 22 to 25 are connected oppositely in polarities according to the method mentioned above as well.

Wherein, the controller 16 comprises a first pin 161 and a plurality of second pins 16a to 16e. The first pin 161 is connected to the first terminal of each light-emitting device 21 to 25. The second pins 16a to 16e are connected to the second terminal of each corresponding light-emitting device 21 to 25 respectively. The controller selectively alters the output voltage polarities or values between the first pin 161 and the second pin 16a to 16e (which is the output voltage polarities or values between the first terminal and the second terminal as well). For example, when the second pins 16a to 16e are grounding, the first pin 161 outputs a 5.0V voltage to drive the second color light-emitting diode 21b to 25b to light; or when the first pin is grounding, the second pins 16a to 16e can output a −5.0V voltage to drive the second color light-emitting diode 21b to 25b to light as well. That is to say if the voltage of the first pin 161 is higher than the voltage of the second pins 16a to 16e for a predetermined value (for example, between 2 to 5), then the second color light-emitting diodes 21b to 25b will light. However, when the second pin 16a to 16e generates a 5.0V voltage, the first color light-emitting diodes 21a to 25a will light through the first pin which is grounded; or when the first pin 161 generates a −5.0V voltage, the first color light-emitting diodes 21a to 25a will light through the second pins 16a to 16e which are grounded. That is to say if the voltages of the second pins 16a to 16e are higher than the voltage of the first pin 161 for a predetermined value (for example, between 2 to 5), then the first color light-emitting diodes 21b to 25b will light. The controller 16 can allow each light-emitting device to generate different colors by altering the output voltage polarities or values from the controller 16 to the position between the first terminal and the second terminal of the light-emitting devices. And then the controller 16 can alter the output voltage polarities or values in different time period from the controller 16 to the position between the first terminal and the second terminal of light-emitting devices for generating many different kinds of lighting patterns with different colors.

In a first embodiment, the absolute value of the voltage difference between the first terminal and the second terminal while the first color light-emitting diode of the light-emitting device is lighting can be equal or unequal to the absolute value of the voltage difference between the first terminal and the second terminal while the second color light-emitting diode of the light-emitting device is lighting. In a second embodiment, the lighting colors of the first color light-emitting diodes of each light-emitting device can be the same or different, and the lighting colors of the second color light-emitting diodes of each light-emitting device can be the same or different. In another embodiment, the first embodiment mentioned above can be combined with the second embodiment mentioned above.

Furthermore, one method for the controller 16 to control the light-emitting devices 21 to 25 to light is as follows: upon the controller 16 receives the trigger signal generated from the motion actuated switch 14, the controller 16 starts to drive the light-emitting device 21 to 25 to light. When the light-emitting device is lighting in a predetermined way, the trigger signal generated from the motion actuated switch 14 will not be accepted until the lighting is over.

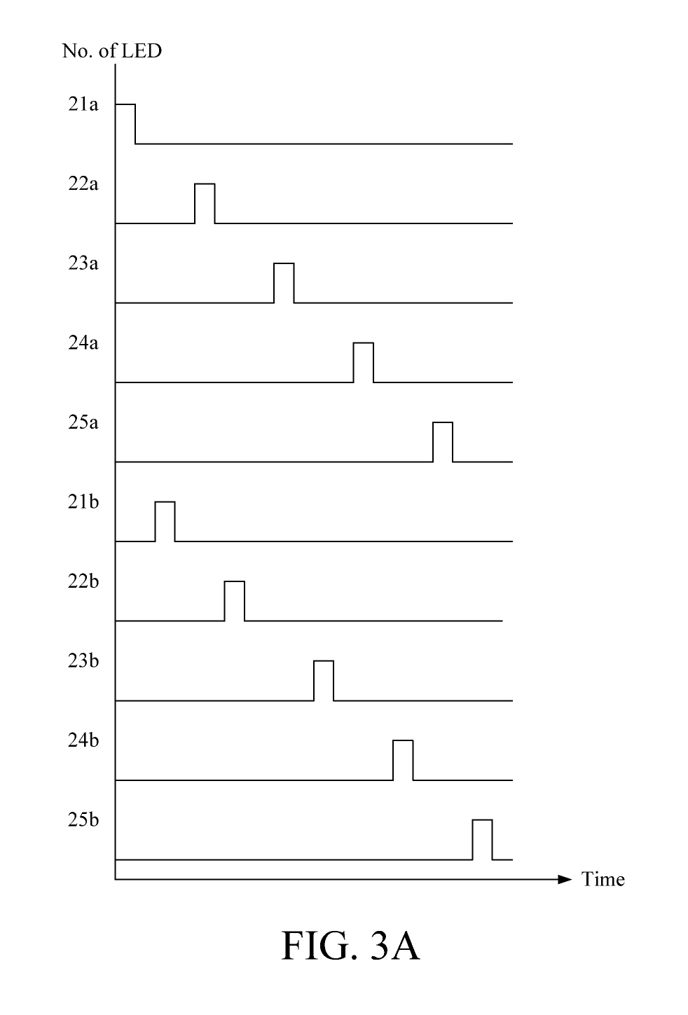

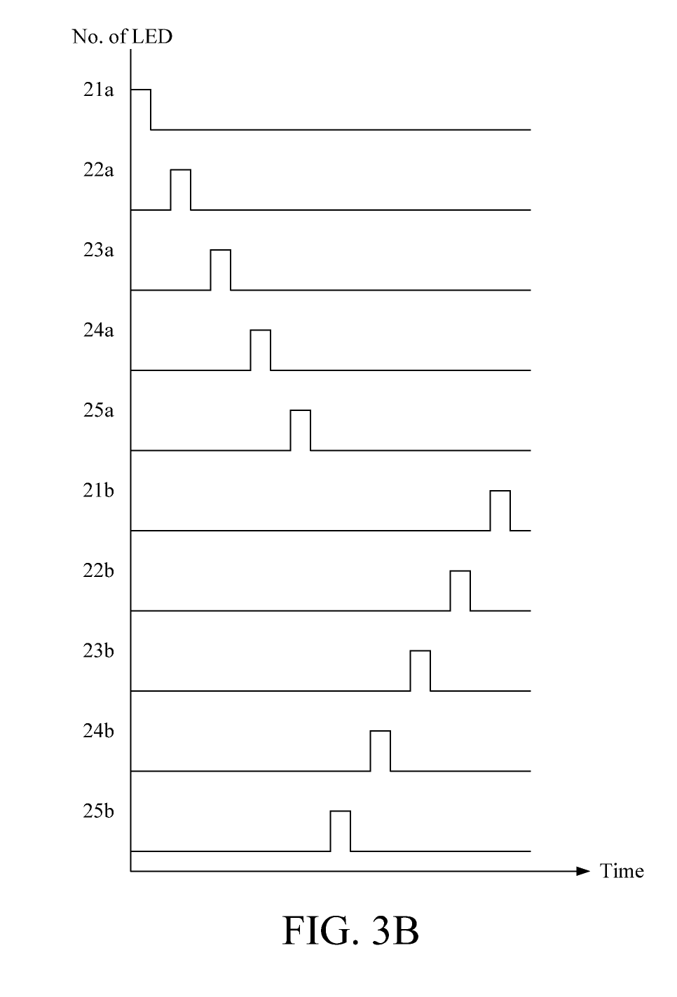

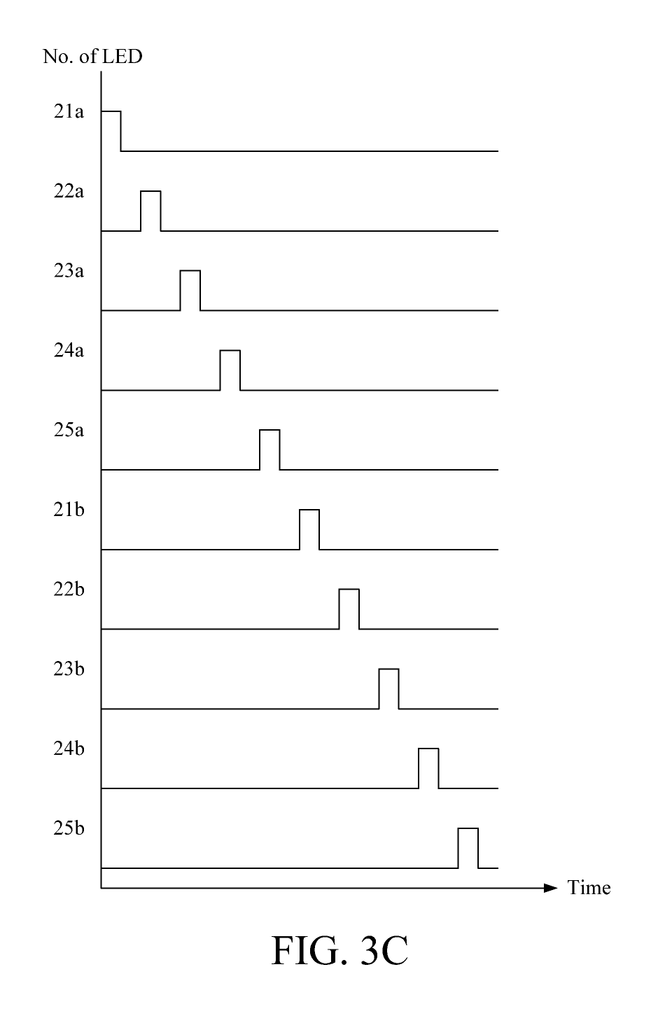

In an embodiment, lighting in the predetermined way is that the controller 16 drives the light-emitting devices 21 to 25 respectively to light for two times in a sequence (wherein the sequence is 21, 22, 23, 24, 25) to form a lighting cycle, and then repeats the lighting cycle for N times, wherein the N is a natural number. More particularly, the controller 16 controls to output a forward voltage to the position between the second pin 16a and the first pin 161, which allows the first color light-emitting diode 21a of the light-emitting device 21 to light and then light-off. And after the first color light-emitting diode 21a of the light-emitting device 21 is lighting-off, the controller 16 controls to output a backward voltage to the position between the second pin 16a and the first pin 161, which allows the second color light-emitting diode 21b of the light-emitting device 21 to light and then light-off. That is, the controller 16 alternately outputs the forward voltage and the backward voltage for many times to allow the first color light-emitting diodes 21a to 25a and the second light-emitting diodes 21b to 25b of the light-emitting devices 21 to 25 to light in a sequence respectively for forming a lighting cycle. And then the lighting cycle is repeated for N times, such as 3 times. Before the lighting cycle is repeated, the light-emitting devices 21-25 respectively to light for two times. The statement mentioned above can be referred in the FIG. 3A, which shows the schematic blinking diagram in an embodiment of the present invention, wherein the horizontal axis is time, the vertical axis is the number of the light-emitting diodes, and each peak means the light-emitting diode is lighting.

In another embodiment, lighting in the predetermined way is that the controller 16 drives the light-emitting devices 21 to 25 respectively to light for one time in a forward sequence (wherein the forward sequence is 21, 22, 23, 24, 25) and drives the light-emitting devices 21 to 25 respectively for one time in a reverse sequence (wherein the reverse sequence is 25, 24, 23, 22, 21) to form a lighting cycle, and then repeats the lighting cycle for N times, wherein the N is a natural number. More particularly, the controller 16 controls to output a forward voltage to the position between the second pins 16a to 16e and the first pin 161, which allows the first color light-emitting diode 21a to 25a of the light-emitting device 21 to 25 to light and light-off respectively and forms a lighting sequence of the light-emitting devices 21 to 25. And after the first color light-emitting diode 21a to 25a of the light-emitting device 21 to 25 is lighting-off, the controller 16 controls to output a backward voltage to the position between the second pins 16e to 16a and the first pin 161, which allows the second color light-emitting diode 25b to 21b to light and light-off respectively. And then the above-mentioned lighting cycle is repeated for N times, such as 3 times. The lighting cycle of light-emitting device 21 to 25 lighting from 21 to 25 and then from 25 to 21 can be referred in FIG. 3B, which shows the schematic blinking diagram in another embodiment of the present invention, wherein the horizontal axis is time, the vertical axis is the number of the light-emitting diodes, and each peak means the light-emitting diode is lighting.

In another embodiment, the controller 16 first coutputs a forward voltage to the position between the second pins 16a to 16e and the first pin 161, which allows the first color light-emitting diode 21a to 25a of the light-emitting device 21 to 25 to light and light-off respectively. Thereafter the controller 16 outputs a backward voltage to the position between the second pins 16a to 16e and the first pin 161, which allows the second color light-emitting diode 21b to 25b to light and light-off respectively. And then the above-mentioned lighting cycle is repeated for N times, such as 3 times. The lighting cycle of light-emitting device 21 to 25 from 21 to 25 in this embodiment can be referred in FIG. 3C, which shows the schematic blinking diagram in another embodiment of the present invention, wherein the horizontal axis is time, the vertical axis is the number of the light-emitting diodes, and each peak means the light-emitting diode is lighting.

Obviously, the circuit device of the present invention is close, simple, and energy conservation, which can be used on various objects or products to provide a bigger area for lighting/blinking. Furthermore, the circuit device can be applied on any object in need easily for providing noticeable and sufficient lighting to the activities at night.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A circuit device, used to control a plurality of light-emitting devices disposed on an object, comprising:
a motion actuated switch, used to generate a trigger signal in response to a motion of the object;
a controller, electrically coupled to the motion actuated switch; and
a battery, used to supply the motion actuated switch, the controller, and the plurality of light-emitting devices with electrical power;
wherein each light-emitting device comprises two light-emitting diodes connected oppositely in polarities, upon the controller receiving the trigger signal, the controller drives the plurality of light-emitting devices to light in a predetermined way by altering the output voltage polarities or values from the controller to the plurality of light-emitting devices.

2. The circuit device of claim 1, wherein lighting in the predetermined way is that the plurality of light-emitting devices respectively light for two times in a sequence to form a lighting cycle, and then repeats the lighting cycle for N times, wherein the N is a natural number.

3. The circuit device of claim 1, wherein lighting in the predetermined way is that the plurality of light-emitting devices respectively light for one time in a forward sequence and then respectively light for one time in a reverse sequence to form a lighting cycle, and then repeats the lighting cycle for N times, wherein the N is a natural number.

4. The circuit device of claim 1, wherein lighting in the predetermined way is that the plurality of light-emitting devices respectively light for one time in a sequence which is repeatedly for two times to form a lighting cycle, and then repeats the lighting cycle for N times, wherein the N is a natural number.

5. The circuit device of claim 1, wherein the two light-emitting diodes connected oppositely in polarities is that each light-emitting diode has a positive pole and a negative pole, the positive pole of the light-emitting diode is connected to the negative pole of the other light-emitting diode, and the negative pole of the light-emitting diode is connected to the positive pole of the other light-emitting diode.

6. The circuit device of claim 1, wherein the controller comprises a first pin and a plurality of second pins, the first pin is coupled to each light-emitting device respectively, each second pin is coupled to the corresponding light-emitting device respectively, and the output voltage polarities or values altered by the controller are the output voltage polarities or values between the first pin and the second pin.

7. A object embedding a circuit device to control a plurality of light-emitting devices, comprising:
a motion actuated switch, used to generate a trigger signal in response to a motion;
a controller, electrically coupled to the motion actuated switch, wherein the controller drives the plurality of light-emitting devices to light according to the trigger signal; and
a battery, used to supply the motion actuated switch, the controller, and the plurality of light-emitting devices with electrical power;
wherein each light-emitting device comprises two light-emitting diodes which are coupled to the controller and connected oppositely in polarities, and the controller drives the plurality of light-emitting devices to light by altering the output voltage polarities or values to the plurality of light-emitting devices.

8. The object of claim 7, wherein each light-emitting device comprises a first terminal, a second terminal, and a first color light-emitting diode and a second color light-emitting diode which are connected oppositely in polarities and positioned between the first terminal and the second terminal, the controller drives the plurality of light-emitting devices to light in a predetermined way by selectively altering the output voltage polarities or values between the first terminal and the second terminal.

9. The object of claim 8, wherein lighting in the predetermined way is that the first color light-emitting diode and the second color light-emitting diode in each light-emitting device to light sequentially.

10. The object of claim 8, wherein lighting in the predetermined way is that the first color light-emitting diode of each light-emitting device respectively lights for one time in a forward sequence and then the second color light-emitting diode of each light-emitting device respectively lights for one time in the forward sequence.

11. The object of claim 8, wherein lighting in the predetermined way is that the first color light-emitting diode of each light-emitting device respectively lights for one time in a forward sequence and then the second color light-emitting diode of each light-emitting device respectively lights for one time in a reverse sequence.

12. The object of claim 7, wherein the first terminal of each light-emitting device is coupled to a corresponding LED pin of the controller respectively, the second terminal of each light-emitting device is collectively coupled to a common pin of the controller, the controller drives the plurality of light-emitting devices to light by selectively altering the output voltage polarities or values between the corresponding LED pin and the common pin.

13. A circuit device, comprising:
a motion actuated switch, used to generate a trigger signal in response to a motion; and
a controller, electrically coupled to the motion actuated switch, wherein the controller comprises a plurality of LED pins and a common pin, each LED pin is respectively coupled to a first terminal of a first color light-emitting diode and a second terminal of a second color light-emitting diode, a second terminal of each first color light-emitting diode and a first terminal of each second color light-emitting diode are collectively coupled to the common pin, and the controller selectively alters the output voltage polarities or values between the LED pin and the common pin according to the trigger signal.

14. The circuit device of claim 13, wherein the first terminal of the first color light-emitting diode and the first terminal of the second color light-emitting diode are positive pole, and the second terminal of the first color light-emitting diode and the second terminal of the second color light-emitting diode are negative pole.
